(19) United States
(12) Patent Application Publication
(10) Pub. No.: US 2026/0080372 A1
(43) Pub. Date: Mar. 19, 2026

(54) TIMING RECOMMENDATION OF SERVER DECOMMISSIONING

(71) Applicant: Microsoft Technology Licensing, LLC, Redmond, WA (US)

(72) Inventors: Chenmin YU, Redmond, WA (US); Shuiyuan DING, Redmond, WA (US); Huanghao XU, Suzhou (CN); Jiayin HAN, Redmond, WA (US); Fanchen MENG, Redmond, WA (US); Junjun SANG, Suzhou (CN); Seshadri SRIPERUMBUDUR, Redmond, WA (US); Boon Pin YEAP, Redmond, WA (US); Scott GARGASH, Redmond, WA (US); Joshua M. FOOKS, Redmond, WA (US); Ting ZHU, Redmond, WA (US)

(21) Appl. No.: 18/998,051

(22) PCT Filed: Sep. 23, 2022
(86) PCT No.: PCT/CN2022/120710

§ 371 Date: Jan. 23, 2025

(51) Int. Cl. G06Q 10/30; G06Q 10/20

(52) U.S. Cl. CPC G06Q 10/30; G06Q 10/20

(57) ABSTRACT

The present disclosure provides methods and apparatuses for providing timing recommendation of server decommissioning in a cloud service platform. Multi-modal data associated with decommissioning-decision made to a target server in the cloud service platform may be obtained. A maintenance cost curve of the target server and at least one of a server additional value curve of the target server and a replacement server cost line of a replacement server may be generated based on the multi-modal data. Decommissioning timing recommendation of the target server may be determined according to the maintenance cost curve and at least one of the server additional value curve and the replacement server cost line.

### BACKGROUND

Cloud service platform may provide various cloud services to users. Usually, a cloud service platform comprises multiple data centers, and each data center comprises a large amount of servers. The servers in the cloud service platform provide various resources for the cloud services, e.g., storage resources, computing resources, etc. To ensure the stability of the cloud services, systematic and intelligent management of the servers in the cloud service platform is needed.

### SUMMARY

This Summary is provided to introduce a selection of concepts that are further described below in the Detailed Description. It is not intended to identify key features or essential features of the claimed subject matter, nor is it intended to be used to limit the scope of the claimed subject matter.

Embodiments of the present disclosure propose methods and apparatuses for providing timing recommendation of server decommissioning in a cloud service platform. Multi-modal data associated with decommissioning-decision made to a target server in the cloud service platform may be obtained. A maintenance cost curve of the target server and at least one of a server additional value curve of the target server and a replacement server cost line of a replacement server may be generated based on the multi-modal data. Decommissioning timing recommendation of the target server may be determined according to the maintenance cost curve and at least one of the server additional value curve and the replacement server cost line.

It should be noted that the above one or more aspects comprise the features hereinafter fully described and particularly pointed out in the claims. The following description and the drawings set forth in detail certain illustrative features of the one or more aspects. These features are only indicative of the various ways in which the principles of various aspects may be employed, and this disclosure is intended to include all such aspects and their equivalents.

### BRIEF DESCRIPTION OF THE DRAWINGS

The disclosed aspects will hereinafter be described in connection with the appended drawings that are provided to illustrate and not to limit the disclosed aspects.

FIG. 1 illustrates an exemplary process of providing timing recommendation of server decommissioning in a cloud service platform according to an embodiment.

FIG. 2 illustrates an exemplary server additional value curve, an exemplary maintenance cost curve and an exemplary replacement server cost line according to an embodiment.

FIG. 3 illustrates exemplary decommissioning timing decision mechanism according to an embodiment.

FIG. 4 illustrates exemplary decommissioning timing decision mechanism according to an embodiment.

FIG. 5 illustrates exemplary decommissioning timing decision mechanism according to an embodiment.

FIG. 6 illustrates exemplary decommissioning timing decision mechanism according to an embodiment.

FIG. 7 illustrates a flowchart of an exemplary method for providing timing recommendation of server decommissioning in a cloud service platform according to an embodiment.

FIG. 8 illustrates an for providing timing recommendation of server decommissioning in a cloud service platform according to an embodiment.

FIG. 9 illustrates an exemplary apparatus for providing timing recommendation of server decommissioning in a cloud service platform according to an embodiment.

### DETAILED DESCRIPTION

The present disclosure will now be discussed with reference to several example implementations. It is to be understood that these implementations are discussed only for enabling those skilled in the art to better understand and thus implement the embodiments of the present disclosure, rather than suggesting any limitations on the scope of the present disclosure.

In order to ensure normal functionality and performance of servers in a cloud service platform, existing server management relies on a predefined lifetime of servers. A predefined lifetime of a server may refer to a time period during which functionality and performance of the server can be kept in a good condition through various approaches. As an example, a predefined lifetime of a server may be a warranty period during which a provider of the server may provide free replacement of components in the server so as to ensure normal functionality and performance of the server. Usually, a server will be decommissioned once a predefined lifetime of the server expired. However, this server may be still healthy at the end of the predefined lifetime, e.g., the server is still capable of providing normal storage resources, computing resources, etc. In this case, decommissioning of the server at the end of the predefined lifetime would result in a waste from a cost-effective perspective or from a data center sustainability perspective.

To solve the above server decommissioning problem, an existing solving approach is proposed to find a suitable time period for decommissioning a server based on a capex cost curve and a maintenance cost curve. The capex cost curve represents dynamic value of the server during a time period, and the maintenance cost curve represents dynamic cost that is needed to pay for the server during the time period. Both the capex cost curve and the maintenance cost curve are mathematically defined as continuous functions, and a suitable time period for decommissioning the server is determined based on an analytical solution of the two continuous functions. However, in practice, it is difficult to find or define such continuous functions for the capex cost curve and the maintenance cost curve. For example, it is hard to find a continuous function for the maintenance cost curve because of uncertainties of server failure, degree of damage to a server, operating environment of a server, etc. Accordingly, it is difficult to get the desired analytical solution properly from the capex cost curve and the maintenance cost curve, and thus it is difficult to find a proper and suitable time period for decommissioning a server in this way.

Embodiments of the present disclosure propose an effective approach of helping an administrator of a cloud service platform to make server decommissioning decision. The embodiments of the present disclosure may provide effective and helpful timing recommendation of server decommissioning in a cloud service platform. Compared with the above existing approach, the embodiments of the present disclosure do not adopt the capex cost curve involved in the existing approach, and utilizes a maintenance cost curve that is based on a discrete function rather than the continuous function-based maintenance cost curve involved in the existing approach.

The embodiments of the present disclosure may find suitable timing for server decommissioning through comparison among server additional value, maintenance cost and replacement server cost. For example, the embodiments of the present disclosure may utilize a server additional value curve, a maintenance cost curve, a replacement server cost line, etc. for determining suitable decommissioning timing. A server additional value function, a maintenance cost function and a replacement server cost function are defined for generating the server additional value curve, the maintenance cost curve and the replacement server cost line based on multi-modal data, respectively. Multiple types or levels of decommissioning timing can be recommended according to multiple types of decommissioning timing decision mechanism, such that different actions can be taken to a server at different timings. The embodiments of the present disclosure can get a numerical solution from the server additional value curve, the maintenance cost curve and the replacement server cost line, which is more practical than finding an analytical solution as in the existing approach.

Through the embodiments of the present disclosure, reasonable timing recommendation of server decommissioning can be provided, such that servers in the cloud service platform can remain to be deployed for providing cloud services even going beyond a predefined lifetime of the servers, and meanwhile the functionality and performance of the servers can still be in a healthy state. Accordingly, the expense of server deployment in the cloud service platform can be effectively and significantly reduced or saved.

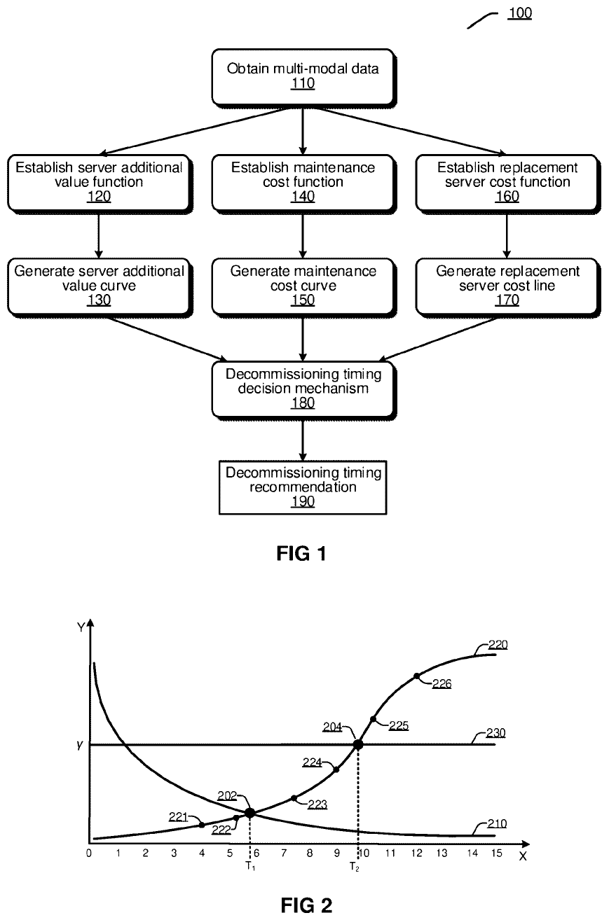

FIG. 1 illustrates an exemplary process 100 of providing timing recommendation of server decommissioning in a cloud service platform according to an embodiment. The process 100 may be performed for providing timing recommendation of server decommissioning with respect to a certain server or anyone of multiple servers having the same type or configuration in the cloud service platform. Accordingly, decommissioning timing recommendation produced by the process 100 can be utilized for deciding whether to decommission the certain server or the multiple servers of the same type or configuration. Hereinafter, the certain server or the multiple servers of the same type or configuration may be referred to as a target server.

At 110, multi-modal data associated with decommissioning-decision made to the target server in the cloud service platform is obtained. The multi-modal data may be obtained from various databases that store information related to the operating, management, maintenance, etc. of servers in the cloud service platform. The embodiments of the present disclosure are not limited to any specific approach of obtaining the multi-modal data.

Various types of data or information that are useful for deciding whether to decommission the target server may be included in the multi-modal data.

The multi-modal data may comprise target server capex information. The target server capex information indicates a capex of the target server that is paid at once for acquiring the target server.

The multi-modal data may comprise replacement server capex information. The target server capex information indicates a capex of a replacement server that is paid at once for acquiring the replacement server. Herein, the replacement server refers to a server that is used for replacing the target server if the target server is decommissioned.

The multi-modal data may comprise parameter information of the target server and parameter information of the replacement server. Parameter information indicates a size of a parameter of a server, wherein the parameter may be, e.g., storage space size, computing power, etc. Taking the parameter being storage space size as an example, the parameter information of the target server refers to a storage space size offered by the target server, and the parameter information of the replacement server refers to a storage space size offered by the replacement server.

The multi-modal data may comprise usage age information and offline duration information. In an implementation, the usage age information and the offline duration information may be obtained from historical data of reference servers that correspond to the target server. The reference servers may have the same type or configuration as the target server, and thus historical data of these reference servers may be deemed as data associated with the target server and be used for deciding whether to decommission the target server. Usually, a server may suffer offline events periodically or occasionally due to routine check, fault restoration, component replacement, etc. The cloud service platform may record various types of information related to these offline events, e.g., usage age information, offline duration information, etc. The usage age information indicates a usage age of a server when an offline event occurs, wherein the usage age is counted since the server is deployed for operating in the cloud service platform. The offline duration information indicates a time length, e.g., in unit of hour, that the offline event lasts.

The multi-modal data may comprise hosting cost information. The hosting cost information indicates a cost for hosting a server in a data center per unit time, e.g., per hour.

The multi-modal data may comprise usage age information, replacement component information and component price information. In an implementation, the usage age information, the replacement component information and the component price information may be obtained from historical data of reference servers that correspond to the target server. A server may suffer a component replacement event in which a component in the server that does not work well may be replaced by a new replacement component. The cloud service platform may record various types of information related to such component replacement events, e.g., usage age information, replacement component information, component price information, etc. The usage age information indicates a usage age of a server when a component replacement event occurs. The replacement component information indicates what component is used for replacing the original component in the component replacement event, and the component price information indicates a price of the replacement component.

The multi-modal data may comprise predefined lifetime information. The predefined lifetime information indicates a predefined lifetime that is set for the target server or its reference servers.

It should be understood that the multi-modal data obtained at 110 may comprise any one or more types of the above exemplary information, and may also comprise any other types of information that are associated with decommissioning-decision made to the target server.

According to the embodiments of the present disclosure, the obtained multi-modal data may be used for generating a server additional value curve of the target server, a maintenance cost curve of the target server, a replacement server cost line of a replacement server respectively. For example, a server additional value function, a maintenance cost function and a replacement server cost function may be established and used for generating the server additional value curve, the maintenance cost curve and the replacement server cost line based on the multi-modal data, respectively.

At 120, a server additional value function may be established. The server additional value function may characterize additional value which is brought about due to an extended usage time period of the target server. Server additional value calculated by the server additional function may reflect how much expense can be saved. Herein, the extended usage time period is referred to as a reference time span. The server additional value function may be established with a depreciation difference. The depreciation difference refers to a difference between an original depreciation calculated based on a usage age of the target server and a reference depreciation calculated based on the usage age and the reference time span. The target server capex information included in the multi-modal data may be used for calculating the original depreciation and the reference depreciation. As an example, the server additional value function may be defined as:

$$f ( x , n ) = \frac{{C}_{1}}{x} - \frac{{C}_{1}}{x + n} \qquad Equation ( 1 )$$

wherein ƒ(x, n) is the server additional value function, x denotes a usage age of the target server, n denotes a reference time span, C₁ denotes target server capex,

$$\frac{{C}_{1}}{x}$$

denotes an original depreciation of the target server at the usage age x, and

$$\frac{{C}_{1}}{x + n}$$

denotes a reference depreciation of the target server at the age x+n. The defined server additional value function is a continuous function.

It should be understood that the above Equation (1) is only an example for defining the server additional value function. The embodiments of the present disclosure may also define the server additional value function in any other approaches. For example, instead of adopting

$$\frac{{C}_{1}}{x} and \frac{{C}_{1}}{x + n} ,$$

which are in a linear depreciation calculation approach, for calculating the original depreciation and the reference depreciation, the original depreciation and the reference depreciation may also be calculated in any other non-linear depreciation calculation approaches. The embodiments of the present disclosure are not limited to any specific approaches for defining the server additional value function.

At 130, a server additional value curve may be generated according to the established server additional value function. For example, the server additional value curve may be drawn according to the server additional value function, wherein X-axis denotes usage age of the target server, and Y-axis denotes additional value of the target server.

At 140, a maintenance cost function may be established. The maintenance cost function may characterize maintenance cost which is brought about due to server maintenance events, e.g., offline events, component replacement events, etc. The maintenance cost may reflect how much expense shall be paid for the maintenance events. The maintenance cost function may be established with offline waste cost and/or component replacement cost calculated over the reference time span.

In an aspect, an offline waste cost function may be defined for calculating offline waste cost over the reference time span. The offline waste cost function may calculate the offline waste cost over the reference time span based at least on usage age information, offline duration information, hosting cost information, etc. included in the multi-modal data. For example, the offline waste cost function may be defined as:

$$w ( x , n ) = {\sum }_{n} ( hc * h ( x ) ) \qquad Equation ( 2 )$$

wherein w(x, n) is the offline waste cost function, x denotes a usage age of a server, n denotes a reference time span, hc denotes hosting cost, and h(x) denotes offline duration at the age x. Through the Equation (2), an offline waste cost in each year ranged from the age x to the age x+n is calculated respectively, and accumulated over the reference time span n, thus obtaining the total offline waste cost during the reference time span n. It should be understood that the above Equation (2) is only an example for defining the offline waste cost function, and the embodiments of the present disclosure are not limited to any specific approaches for defining the offline waste cost function.

In another aspect, a component replacement cost function may be defined for calculating component replacement cost over the reference time span. The component replacement cost function may calculate the component replacement cost over the reference time span based at least on usage age information, replacement component information, component price information, etc. in the multi-modal data. For example, the component replacement cost function may be denoted as r(x, n, o, p), wherein x denotes a usage age of a server, n denotes a reference time span, o denotes replacement components, and p denotes prices of the replacement components. The component replacement cost function may calculate the total cost of all the replacement components adopted over the reference time span. It should be understood that the embodiments of the present disclosure are not limited to any specific approaches for defining the component replacement cost function.

In an implementation, the maintenance cost function may be defined as:

$$m ( x , n ) = \{ \begin{matrix}w ( x , n ) , & x \leq T \\ w ( x , n ) + r ( x , n , o , p ) , & x > T\end{matrix} \qquad Equation ( 3 )$$

wherein m(x, n) is the maintenance cost function, w(x, n) is the offline waste cost function, r(x, n, o, p) is the component replacement cost function, and T denotes a predefined lifetime.

According to the Equation (3), in the case that the usage age x of the target server does not exceed the predefined lifetime T, the maintenance cost function may be based on the offline waste cost function w(x, n). In the case that the usage age x of the target server exceeds the predefined lifetime T, the maintenance cost function may be based on both the offline waste cost function w(x, n) and the component replacement cost function r(x, n, o, p). In some scenarios, the calculating approaches of maintenance cost within the predefined lifetime and beyond the predefined lifetime may be different from each other. Taking the predefined lifetime being a warranty period as an example, if free component replacement is promised during the warranty period, component placement cost can be considered only after the end of the warranty period and is not needed to consider within the warranty period, as shown in the Equation (3).

The defined maintenance cost function is a discrete function, and the maintenance cost is defined as a random variable changed over time. The maintenance cost may be calculated at least with historical data of reference servers corresponding to the target server in the multi-modal data, wherein the historical data may be deemed as a series of discrete data items. Accordingly, the maintenance cost function may calculate multiple discrete maintenance costs based on the discrete historical data.

It should be understood that the above Equation (3) is only an example for defining the maintenance cost function. The embodiments of the present disclosure may cover various approaches for defining the maintenance cost function. For example, in addition to the offline waste cost function and the component replacement cost function, the maintenance cost function may be established further based on any other factors that result in certain costs over the reference time span, e.g., labor cost involved in maintenance, etc. For example, instead of considering the predefined lifetime, the maintenance cost function may be established without adopting the predefined lifetime, and thus the same calculating approach may be applied for calculating maintenance cost within the predefined lifetime and beyond the predefined lifetime. For example, instead of utilizing both the offline waste cost function and the component replacement cost function for defining the maintenance cost function, it is also possible to utilize any one of the offline waste cost function and the component replacement cost function for defining the maintenance cost function.

At 150, a maintenance cost curve may be generated according to the established maintenance cost function. In an implementation, the maintenance cost function may be used for determining multiple discrete points firstly, wherein the multiple discrete points correspond to multiple discrete maintenance costs calculated by the maintenance cost function based on the discrete historical data. Then, a fitting process may be performed to the multiple discrete points so as to form the maintenance cost curve, wherein X-axis denotes server usage age, and Y-axis denotes maintenance cost.

At 160, a replacement server cost function may be established. The replacement server cost function may characterize cost which is brought about due to replacing the target server by a replacement server. Replacing server cost calculated by the replacing server cost function is a metric of expense that shall be paid for server replacement. The replacement server cost function may be established at least through performing parameter normalization to a capex of the replacement server. Replacement server cost may be calculated by the replacement server cost function based at least on replacement server capex information, parameter information of the target server, parameter information of the replacement server included in the multi-modal data. As an example, the replacement server cost function may be defined as:

$$γ = \frac{{C}_{2}}{{S}_{2}} * {S}_{1} \qquad Equation ( 4 )$$

wherein γ is the replacement server cost function, C₂ denotes replacement server capex. S₂ denotes parameter information of the replacement server, and S₁ denotes parameter information of the target server.

$$\frac{{C}_{2}}{{S}_{2}}$$

represents the fee needed to pay for the replacement server per parameter unit, and the multiplication of

$$\frac{{C}_{2}}{{S}_{2}}$$

with S₁ represents the cost needed to pay for the replacement server for the purpose of achieving the parameter of the target server, i.e., the replacement server cost. Through introducing S₂ and S₁ into the replacement server cost function, the replacement server capex can be normalized, thus the obtained replacement server cost is more reasonable and comparable. Taking the parameter corresponding to a storage space size as an example, S₂ denotes a storage space size of the replacement server, S₁ denotes a storage space size of the target server,

$$\frac{{C}_{2}}{{S}_{2}}$$

represents the fee needed to pay for the replacement server per storage unit, and the multiplication of

$$\frac{{C}_{2}}{{S}_{2}}$$

with S₁ represents the cost needed to pay for the replacement server for the purpose of achieving the storage space size of the target server. The defined replacement server cost function may produce a constant γ as the replacement server cost.

It should be understood that the above Equation (4) is only an example for defining the replacement server cost function. The embodiments of the present disclosure are not limited to any specific approaches for defining the replacement server cost function.

At 170, a replacement server cost line may be generated according to the established replacement server cost function. For example, the replacement server cost line may be drawn according to the constant γ calculated by the replacement server cost function, wherein X-axis denotes usage age of the target server and Y-axis denotes replacement server cost of the replacement server.

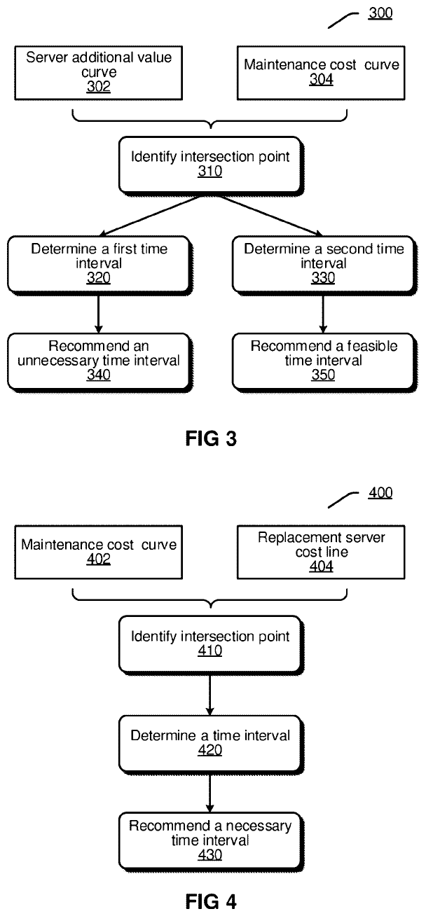

At 180, decommissioning timing decision mechanism may be applied according to the server additional value curve, the maintenance cost curve and the replacement server cost line, so as to determine decommissioning timing recommendation 190 of the target server. The decommissioning timing decision mechanism may determine decommissioning timing recommendation 190 through making comparison among server additional value, maintenance cost and replacement server cost by using the server additional value curve, the maintenance cost curve and the replacement server cost line. The embodiments of the present disclosure propose a plurality of types of decommissioning timing decision mechanism for determining different types or levels of decommissioning timing, which will be further discussed in connection with FIG. 3 to FIG. 6 later.

It should be understood that although it is shown in the process 100 that all of the server additional value curve, the maintenance cost curve and the replacement server cost line are used for determining decommissioning timing recommendation, depending on different decommissioning timing decision mechanism, it is also possible to utilize only two of them, e.g., only the server additional value curve and the maintenance cost curve, or only the maintenance cost curve and the replacement server cost line, for determining decommissioning timing recommendation. Accordingly, the process 100 may be changed to only include those steps relevant to specific timing decision mechanism.

Moreover, it should be understood that the reference time span n involved in the server additional value function and the maintenance cost function may be effectively used for unifying server additional value calculated by the server additional value function and maintenance cost calculated by the maintenance cost function into the same statistical region, thus facilitating to make comparison between server additional value and maintenance cost by using the server additional value curve and the maintenance cost curve. Moreover, since at least the maintenance cost curve is based on a discrete function (i.e., the maintenance cost function), the process of determining decommissioning timing based on the maintenance cost curve and at least one of the server additional value curve and the replacement server cost line may be deemed as a process of finding a numerical solution which can reflect decommissioning timing properly.

FIG. 2 illustrates an exemplary server additional value curve, an exemplary maintenance cost curve and an exemplary replacement server cost line according to an embodiment.

In FIG. 2, an exemplary server additional value curve 210, an exemplary maintenance cost curve 220 and an exemplary replacement server cost line 230 are put into the same coordinate system in which X-axis denotes usage age of a target server and Y-axis denotes various types of value or cost. For example, for the server additional value curve 210, the maintenance cost curve 220, and the replacement server cost line 230, Y-axis may denote additional value of the target server, maintenance cost, and replacement server cost of the replacement server, respectively.

The server additional value curve 210 is a curve generated according to a continuous server additional value function. The maintenance cost curve 220 is a curve generated through fitting discrete points, e.g., points 221 to 226, determined by a discrete maintenance cost function. The replacement server cost line 230 is a line with a constant value γ in the Y-axis, wherein γ is calculated by a replacement server cost function.

As shown in FIG. 2, there is an intersection point 202 between the server additional value curve 210 and the maintenance cost curve 220, and there is an intersection point 204 between the maintenance cost curve 220 and the replacement server cost line 230. The intersection point 202 corresponds to a time point T₁ in the X-axis, and the intersection point 204 corresponds to a time point T₂ in the X-axis.

It should be understood that the server additional value curve 210, the maintenance cost curve 220 and the replacement server cost line 230 in FIG. 2 are merely exemplary, and depending on various actual scenarios, they may have any other different visual shapes.

FIG. 3 illustrates exemplary decommissioning timing decision mechanism 300 according to an embodiment. The decommissioning timing decision mechanism 300 is an exemplary implementation of the decommissioning timing decision mechanism applied at 180 in FIG. 1. The decommissioning timing decision mechanism 300 takes a server additional value curve 302 and a maintenance cost curve 304 as inputs.

At 310, an intersection point between the server additional value curve 302 and the maintenance cost curve 304 is identified. For example, the intersection point 202 in FIG. 2 may be identified at 310.

At 320, a first time interval is determined, wherein the first time interval is a time interval not exceeding a time point corresponding to the intersection point. For example, in FIG. 2, the first time interval determined at 320 may be a time interval not exceeding the time point T₁ corresponding to the intersection point 202. Within the first time interval, the maintenance cost curve 304 is not higher than the server additional value curve 302. For example, in FIG. 2, the maintenance cost curve 220 is not higher than the server additional value curve 210 within the first time interval.

At 330, a second time interval is determined, wherein the second time interval is a time interval exceeding the time point corresponding to the intersection point. For example, in FIG. 2, the second time interval determined at 330 may be a time interval exceeding the time point T₁ corresponding to the intersection point 202. Within the second time interval, the maintenance cost curve 304 is higher than the server additional value curve 302. For example, in FIG. 2, the maintenance cost curve 220 is higher than the server additional value curve 210 within the second time interval.

At 340, the first time interval determined at 320 may be recommended as an unnecessary time interval. The unnecessary time interval may refer to a time interval within which server decommissioning is unnecessary. For example, within the unnecessary time interval, maintenance cost is not higher than server additional value, and thus it is unnecessary to decommission the target server from a perspective of that the server additional value can bring out expense savings.

At 350, the second time interval determined at 330 may be recommended as a feasible time interval. The feasible time interval may refer to a time interval within which server decommissioning is feasible. For example, within the feasible time interval, maintenance cost is higher than server additional value, and thus decommissioning of the target server may be performed from a perspective of that the server additional value cannot bring out expense savings.

It should be understood that all the steps and their performing orders in the decommissioning timing decision mechanism 300 are exemplary, and the embodiments of the present disclosure may cover various changes to the decommissioning timing decision mechanism 300. Moreover, the combination of the steps 310, 320 and 330 may be deemed as a process of identifying the first time interval and the second time interval.

FIG. 4 illustrates exemplary decommissioning timing decision mechanism 400 according to an embodiment. The decommissioning timing decision mechanism 400 is an exemplary implementation of the decommissioning timing decision mechanism applied at 180 in FIG. 1. The decommissioning timing decision mechanism 400 takes a maintenance cost curve 402 and a replacement server cost line 404 as inputs.

At 410, an intersection point between the maintenance cost curve 402 and the replacement server cost line 404 is identified. For example, the intersection point 204 in FIG. 2 may be identified at 410.

At 420, a time interval is determined, wherein the determined time interval is a time interval exceeding a time point corresponding to the intersection point. For example, in FIG. 2, the time interval determined at 420 may be a time interval exceeding the time point T₂ corresponding to the intersection point 204. Within the determined time interval, the maintenance cost curve 402 is higher than the replacement server cost line 404. For example, in FIG. 2, the maintenance cost curve 220 is higher than the replacement server cost line 230 within the determined time interval.

At 430, the time interval determined at 420 may be recommended as a necessary time interval. The necessary time interval may refer to a time interval within which server decommissioning is necessary. For example, within the necessary time interval, maintenance cost is higher than replacement server cost, and thus it is necessary to decommission the target server from a perspective of that server replacement can bring out expense savings.

It should be understood that all the steps and their performing orders in the decommissioning timing decision mechanism 400 are exemplary, and the embodiments of the present disclosure may cover various changes to the decommissioning timing decision mechanism 400. Moreover, the combination of the steps 410 and 420 may be deemed as a process of identifying the time interval.

FIG. 5 illustrates exemplary decommissioning timing decision mechanism 500 according to an embodiment. The decommissioning timing decision mechanism 500 is an exemplary implementation of the decommissioning timing decision mechanism applied at 180 in FIG. 1. The decommissioning timing decision mechanism 500 takes a server additional value curve 502, a maintenance cost curve 504 and a replacement server cost line 506 as inputs.

At 510, a first intersection point between the server additional value curve 502 and the maintenance cost curve 504 is identified. For example, the intersection point 202 in FIG. 2 may be identified at 510.

At 520, a second intersection point between the maintenance cost curve 504 and the replacement server cost line 506 is identified. For example, the intersection point 204 in FIG. 2 may be identified at 520.

At 530, a first time interval is determined, wherein the first time interval is a time interval not exceeding a first time point corresponding to the first intersection point. For example, in FIG. 2, the first time interval determined at 530 may be a time interval not exceeding the time point T₁ corresponding to the intersection point 202. Within the first time interval, the maintenance cost curve 504 is not higher than the server additional value curve 502. For example, in FIG. 2, the maintenance cost curve 220 is not higher than the server additional value curve 210 within the first time interval.

At 540, a second time interval is determined, wherein the second time interval is a time interval exceeding the first time point corresponding to the first intersection point but not exceeding a second time point corresponding to the second intersection point. For example, in FIG. 2, the second time interval determined at 540 may be a time interval exceeding the time point T₁ corresponding to the intersection point 202 but not exceeding the time point T₂ corresponding to the intersection point 204. Within the second time interval, the maintenance cost curve 504 is higher than the server additional value curve 502 and not higher than the replacement server cost line 506. For example, in FIG. 2, the maintenance cost curve 220 is higher than the server additional value curve 210 and not higher than the replacement server cost line 230 within the second time interval.

At 550, a third time interval is determined, wherein the third time interval is a time interval exceeding the second time point corresponding to the second intersection point. For example, in FIG. 2, the third time interval determined at 550 may be a time interval exceeding the time point T₂ corresponding to the intersection point 204. Within the third time interval, the maintenance cost curve 504 is higher than the replacement server cost line 506. For example, in FIG. 2, the maintenance cost curve 220 is higher than the replacement server cost line 230 within the third time interval.

At 560, the first time interval determined at 530 may be recommended as an unnecessary time interval within which server decommissioning is unnecessary. For example, within the unnecessary time interval, maintenance cost is not higher than server additional value, and thus it is unnecessary to decommission the target server from a perspective of that the server additional value can bring out expense savings.

At 570, the second time interval determined at 540 may be recommended as an operational time interval. The optional time interval may refer to a time interval within which server decommissioning is optional. For example, within the optional time interval, on one hand, maintenance cost is higher than server additional value, and thus decommissioning of the target server may be performed from a perspective of that the server additional value cannot bring out expense savings; and on the other hand, maintenance cost is not higher than replacement server cost, and thus decommissioning of the target server may be not performed from a perspective of that server replacement may bring out higher expense.

At 580, the third time interval determined at 550 may be recommended as a necessary time interval within which server decommissioning is necessary. For example, within the necessary time interval, maintenance cost is higher than replacement server cost, and thus it is necessary to decommission the target server from a perspective of that server replacement can bring out expense savings.

It should be understood that all the steps and their performing orders in the decommissioning timing decision mechanism 500 are exemplary, and the embodiments of the present disclosure may cover various changes to the decommissioning timing decision mechanism 500. Moreover, the combination of the steps 510, 520, 530, 540 and 550 may be deemed as a process of identifying the first time interval, the second time interval and the third time interval.

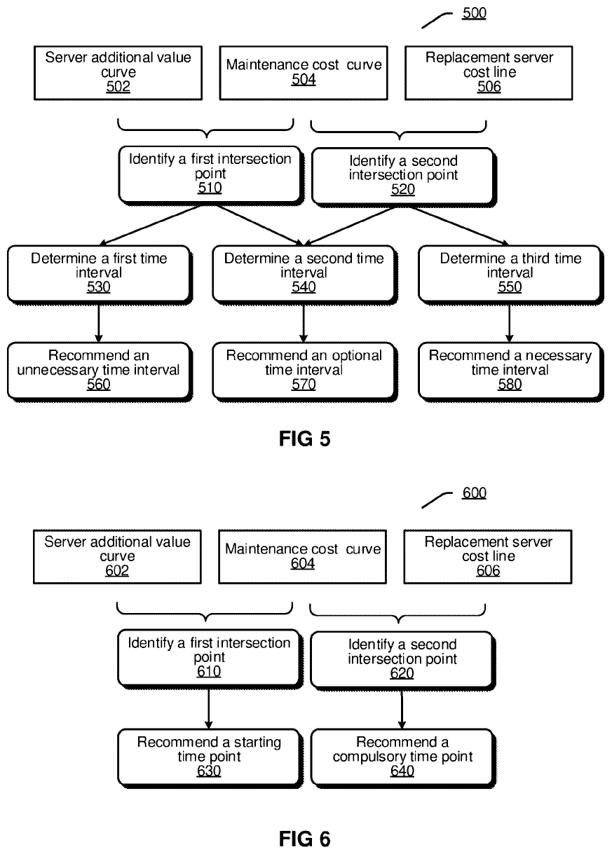

FIG. 6 illustrates exemplary decommissioning timing decision mechanism 600 according to an embodiment. The decommissioning timing decision mechanism 600 is an exemplary implementation of the decommissioning timing decision mechanism applied at 180 in FIG. 1. The decommissioning timing decision mechanism 600 takes a server additional value curve 602, a maintenance cost curve 604 and a replacement server cost line 606 as inputs.

At 610, a first intersection point between the server additional value curve 602 and the maintenance cost curve 604 is identified. For example, the intersection point 202 in FIG. 2 may be identified at 610.

At 620, a second intersection point between the maintenance cost curve 604 and the replacement server cost line 606 is identified. For example, the intersection point 204 in FIG. 2 may be identified at 620.

At 630, a first time point corresponding to the first intersection point may be recommend as a starting time point of server decommissioning. For example, in FIG. 2, the time point T₁ corresponding to the intersection point 202 may be recommend as the starting time point of server decommissioning. The starting time point may indicate that server decommissioning is feasible after this starting time point.

At 640, a second time point corresponding to the second intersection point may be recommend as a compulsory time point of server decommissioning. For example, in FIG. 2, the time point T₂ corresponding to the intersection point 204 may be recommend as the compulsory time point of server decommissioning. The compulsory time point may indicate that server decommissioning is necessary after this compulsory time point.

It should be understood that all the steps and their performing orders in the decommissioning timing decision mechanism 600 are exemplary, and the embodiments of the present disclosure may cover various changes to the decommissioning timing decision mechanism 600. For example, although both the starting time point of server decommissioning and the compulsory time point of server decommissioning are recommended in the decommissioning timing decision mechanism 600, it is also possible to only recommend one of the starting time point and the compulsory time point, and accordingly, the decommissioning timing decision mechanism 600 may be changed to only include those steps relevant to the recommended time point.

The plurality of types of exemplary decommissioning timing decision mechanism discussed above in connection with FIG. 3 to FIG. 6 may be combined in any approaches, and accordingly, the embodiments of the present disclosure may provide various combinations of decommissioning timing recommendations that are produced by the decommissioning timing decision mechanism in FIG. 3 to FIG. 6. Moreover, the embodiments of the present disclosure may cover any other types of decommissioning timing decision mechanism for determining decommissioning timing recommendation based on any two or more of a server additional value curve, a maintenance cost curve and a replacement server cost line.

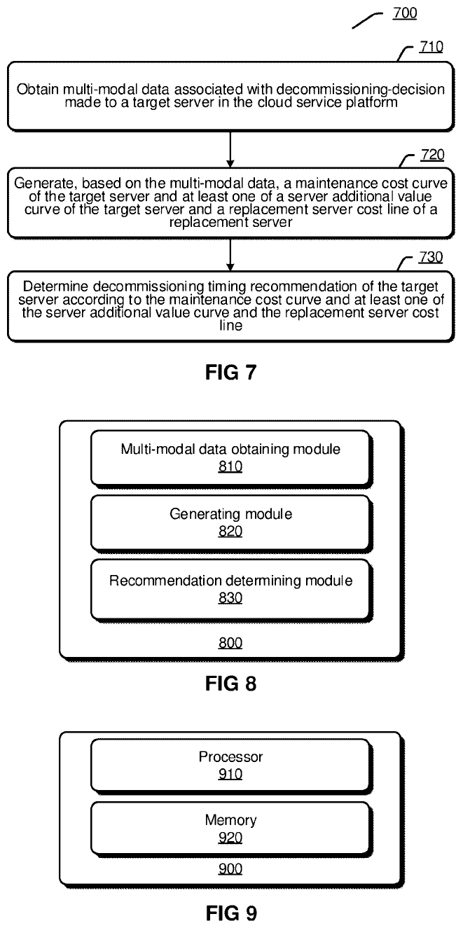

FIG. 7 illustrates a flowchart of an exemplary method 700 for providing timing recommendation of server decommissioning in a cloud service platform according to an embodiment.

At 710, multi-modal data associated with decommissioning-decision made to a target server in the cloud service platform may be obtained.

At 720, a maintenance cost curve of the target server and at least one of a server additional value curve of the target server and a replacement server cost line of a replacement server may be generated based on the multi-modal data.

At 730, decommissioning timing recommendation of the target server may be determined according to the maintenance cost curve and at least one of the server additional value curve and the replacement server cost line.

In an implementation, the determining decommissioning timing recommendation may comprise: identifying a first time interval within which the maintenance cost curve is not higher than the server additional value curve, and a second time interval within which the maintenance cost curve is higher than the server additional value curve; recommending the identified first time interval as an unnecessary time interval within which server decommissioning is unnecessary; and recommending the identified second time interval as a feasible time interval within which server decommissioning is feasible.

The identifying a first time interval and a second time interval may comprise: identifying an intersection point between the server additional value curve and the maintenance cost curve; determining a time interval not exceeding a time point corresponding to the intersection point as the identified first time interval; and determining a time interval exceeding the time point as the identified second time interval.

In an implementation, the determining decommissioning timing recommendation may comprise: identifying a time interval within which the maintenance cost curve is higher than the replacement server cost line; and recommending the identified time interval as a necessary time interval within which server decommissioning is necessary.

The identifying a time interval may comprise: identifying an intersection point between the maintenance cost curve and the replacement server cost line; and determining a time interval exceeding a time point corresponding to the intersection point as the identified time interval.

In an implementation, the determining decommissioning timing recommendation may comprise: identifying a first time interval within which the maintenance cost curve is not higher than the server additional value curve, a second time interval within which the maintenance cost curve is higher than the server additional value curve and not higher than the replacement server cost line, and a third time interval within which the maintenance cost curve is higher than the replacement server cost line; recommending the identified first time interval as an unnecessary time interval within which server decommissioning is unnecessary; recommending the identified second time interval as an optional time interval within which server decommissioning is optional; and recommending the identified third time interval as a necessary time interval within which server decommissioning is necessary.

The identifying a first time interval, a second time interval and a third time interval may comprise: identifying a first intersection point between the server additional value curve and the maintenance cost curve; identifying a second intersection point between the maintenance cost curve and the replacement server cost line; determining a time interval not exceeding a first time point corresponding to the first intersection point as the identified first time interval; determining a time interval exceeding the first time point but not exceeding a second time point corresponding to the second intersection point as the identified second time interval; and determining a time interval exceeding the second time point as the identified third time interval.

In an implementation, the determining decommissioning timing recommendation may comprise at least one of: identifying a first intersection point between the server additional value curve and the maintenance cost curve, and recommending a first time point corresponding to the first intersection point as a starting time point of server decommissioning; and identifying a second intersection point between the maintenance cost curve and the replacement server cost line, and recommending a second time point corresponding to the second intersection point as a compulsory time point of server decommissioning.

In an implementation, the generating a maintenance cost curve and at least one of a server additional value curve and a replacement server cost line may comprise: generating the server additional value curve according to a server additional value function; generating the maintenance cost curve according to a maintenance cost function; and generating the replacement server cost line according to a replacement server cost function.

The server additional value function may be established with a depreciation difference between an original depreciation calculated based on a usage age of the target server and a reference depreciation calculated based on the usage age and a reference time span.

The original depreciation and the reference depreciation may be calculated further based on target server capex information included in the multi-modal data.

The maintenance cost function may be established with offline waste cost and/or component replacement cost calculated over a reference time span.

In the case that a usage age of the target server does not exceed a predefined lifetime, the maintenance cost function may be based on an offline waste cost function. In the case that the usage age of the target server exceeds the predefined lifetime, the maintenance cost function may be based on both the offline waste cost function and a component replacement cost function.

The offline waste cost function may calculate the offline waste cost over the reference time span based at least on usage age information, offline duration information and hosting cost information included in the multi-modal data. The component replacement cost function may calculate the component replacement cost over the reference time span based at least on usage age information, replacement component information and component price information included in the multi-modal data.

The server additional value function may be a continuous function. The maintenance cost function may be a discrete function. The maintenance cost curve may be generated through fitting discrete points determined by the maintenance cost function.

The replacement server cost function may be established at least through performing parameter normalization to a capex of the replacement server.

The replacement server cost function may calculate replacement server cost based at least on replacement server capex information, parameter information of the target server and parameter information of the replacement server included in the multi-modal data.

In an implementation, the multi-modal data may at least comprise historical data of reference servers that correspond to the target server.

Moreover, the method 700 may further comprise any steps/operations for providing timing recommendation of server decommissioning in a cloud service platform according to the above embodiments of the present disclosure.

FIG. 8 illustrates an exemplary apparatus 800 for providing timing recommendation of server decommissioning in a cloud service platform according to an embodiment.

The apparatus 800 may comprise: a multi-modal data obtaining module 810, for obtaining multi-modal data associated with decommissioning-decision made to a target server in the cloud service platform; a generating module 820, for generating, based on the multi-modal data, a maintenance cost curve of the target server and at least one of a server additional value curve of the target server and a replacement server cost line of a replacement server; and a recommendation determining module 830, for determining decommissioning timing recommendation of the target server according to the maintenance cost curve and at least one of the server additional value curve and the replacement server cost line.

Moreover, the apparatus 800 may further comprise any other modules for performing any steps/operations in the methods for providing timing recommendation of server decommissioning in a cloud service platform according to the above embodiments of the present disclosure.

FIG. 9 illustrates an exemplary apparatus 900 for providing timing recommendation of server decommissioning in a cloud service platform according to an embodiment.

The apparatus 900 comprises at least one processor 910. The apparatus 900 further comprises a memory 920 connected to the at least one processor 910. The memory 920 stores computer-executable instructions that, when executed, cause the at least one processor 910 to perform any operations in the methods for providing timing recommendation of server decommissioning in a cloud service platform according to the above embodiments of the present disclosure.

The embodiments of the present disclosure propose a computer program product for providing timing recommendation of server decommissioning in a cloud service platform. The computer program product may comprise a computer program that is executed by at least one processor for performing any steps/operations in the methods for providing timing recommendation of server decommissioning in a cloud service platform according to the above embodiments of the present disclosure.

The embodiments of the present disclosure may be embodied in a non-transitory computer-readable medium. The non-transitory computer-readable medium may comprise instructions that, when executed, cause one or more processors to perform any steps/operations in the methods for providing timing recommendation of server decommissioning in a cloud service platform according to the above embodiments of the present disclosure.

It should be appreciated that all the operations in the methods described above are merely exemplary, and the present disclosure is not limited to any operations in the methods or sequence orders of these operations, and should cover all other equivalents under the same or similar concepts.

Moreover, the articles “a” and “an” as used in this specification and the appended claims should generally be construed to mean “one” or “one or more” unless specified otherwise or clear from the context to be directed to a singular form.

It should also be appreciated that all the modules in the apparatuses described above may be implemented in various approaches. These modules may be implemented as hardware, software, or a combination thereof. Moreover, any of these modules may be further functionally divided into sub-modules or combined together.

Processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in the present disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout the present disclosure. The functionality of a processor, any portion of a processor, or any combination of processors presented in the present disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, threads of execution, procedures, functions, etc. The software may reside on a computer-readable medium. A computer-readable medium may include, by way of example, memory such as a magnetic storage device (e.g., hard disk, floppy disk, magnetic strip), an optical disk, a smart card, a flash memory device, random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout the present disclosure, the memory may be internal to the processors, e.g., cache or register.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein. All structural and functional equivalents to the elements of the various aspects described throughout the present disclosure that are known or later come to be known to those of ordinary skilled in the art are intended to be encompassed by the claims.

1. A method for providing timing recommendation of server decommissioning in a cloud service platform, comprising:
obtaining multi-modal data associated with decommissioning-decision made to a target server in the cloud service platform;
generating, based on the multi-modal data, a maintenance cost curve of the target server and at least one of a server additional value curve of the target server and a replacement server cost line of a replacement server; and
determining decommissioning timing recommendation of the target server according to the maintenance cost curve and at least one of the server additional value curve and the replacement server cost line.

2. The method of claim 1, wherein the determining decommissioning timing recommendation comprises:
identifying a first time interval within which the maintenance cost curve is not higher than the server additional value curve, and a second time interval within which the maintenance cost curve is higher than the server additional value curve;
recommending the identified first time interval as an unnecessary time interval within which server decommissioning is unnecessary; and
recommending the identified second time interval as a feasible time interval within which server decommissioning is feasible.

3. The method of claim 2, wherein the identifying a first time interval and a second time interval comprises:
identifying an intersection point between the server additional value curve and the maintenance cost curve;
determining a time interval not exceeding a time point corresponding to the intersection point as the identified first time interval; and
determining a time interval exceeding the time point as the identified second time interval.

4. The method of claim 1, wherein the determining decommissioning timing recommendation comprises:
identifying a time interval within which the maintenance cost curve is higher than the replacement server cost line; and
recommending the identified time interval as a necessary time interval within which server decommissioning is necessary.

5. The method of claim 4, wherein the identifying a time interval comprises:
identifying an intersection point between the maintenance cost curve and the replacement server cost line; and
determining a time interval exceeding a time point corresponding to the intersection point as the identified time interval.

6. The method of claim 1, wherein the determining decommissioning timing recommendation comprises:
identifying a first time interval within which the maintenance cost curve is not higher than the server additional value curve, a second time interval within which the maintenance cost curve is higher than the server additional value curve and not higher than the replacement server cost line, and a third time interval within which the maintenance cost curve is higher than the replacement server cost line;
recommending the identified first time interval as an unnecessary time interval within which server decommissioning is unnecessary;
recommending the identified second time interval as an optional time interval within which server decommissioning is optional; and
recommending the identified third time interval as a necessary time interval within which server decommissioning is necessary.

7. The method of claim 6, wherein the identifying a first time interval, a second time interval and a third time interval comprises:
identifying a first intersection point between the server additional value curve and the maintenance cost curve;
identifying a second intersection point between the maintenance cost curve and the replacement server cost line;
determining a time interval not exceeding a first time point corresponding to the first intersection point as the identified first time interval;
determining a time interval exceeding the first time point but not exceeding a second time point corresponding to the second intersection point as the identified second time interval; and
determining a time interval exceeding the second time point as the identified third time interval.

8. The method of claim 1, wherein the determining decommissioning timing recommendation comprises at least one of:
identifying a first intersection point between the server additional value curve and the maintenance cost curve, and recommending a first time point corresponding to the first intersection point as a starting time point of server decommissioning; and
identifying a second intersection point between the maintenance cost curve and the replacement server cost line, and recommending a second time point corresponding to the second intersection point as a compulsory time point of server decommissioning.

9. The method of claim 1, wherein the generating a maintenance cost curve and at least one of a server additional value curve and a replacement server cost line comprises:
generating the server additional value curve according to a server additional value function;
generating the maintenance cost curve according to a maintenance cost function; and
generating the replacement server cost line according to a replacement server cost function.

10. The method of claim 9, wherein
the server additional value function is established with a depreciation difference between an original depreciation calculated based on a usage age of the target server and a reference depreciation calculated based on the usage age and a reference time span.

11. The method of claim 10, wherein
the original depreciation and the reference depreciation are calculated further based on target server capex information included in the multi-modal data.

12. The method of claim 9, wherein
the maintenance cost function is established with offline waste cost and/or component replacement cost calculated over a reference time span.

13. The method of claim 12, wherein
in the case that a usage age of the target server does not exceed a predefined lifetime, the maintenance cost function is based on an offline waste cost function, and
in the case that the usage age of the target server exceeds the predefined lifetime, the maintenance cost function is based on both the offline waste cost function and a component replacement cost function.

14. The method of claim 13, wherein
the offline waste cost function calculates the offline waste cost over the reference time span based at least on usage age information, offline duration information and hosting cost information included in the multi-modal data, and
the component replacement cost function calculates the component replacement cost over the reference time span based at least on usage age information, replacement component information and component price information included in the multi-modal data.

15. The method of claim 9, wherein
the server additional value function is a continuous function,
the maintenance cost function is a discrete function, and
the maintenance cost curve is generated through fitting discrete points determined by the maintenance cost function.

16. The method of claim 9, wherein
the replacement server cost function is established at least through performing parameter normalization to a capex of the replacement server.

17. The method of claim 16, wherein
the replacement server cost function calculates replacement server cost based at least on replacement server capex information, parameter information of the target server and parameter information of the replacement server included in the multi-modal data.

18. The method of claim 1, wherein
the multi-modal data at least comprises historical data of reference servers that correspond to the target server.

19. An apparatus for providing timing recommendation of server decommissioning in a cloud service platform, comprising:
at least one processor; and
a memory storing computer-executable instructions that, when executed, cause the at least one processor to perform operations comprising:
obtaining multi-modal data associated with decommissioning-decision made to a target server in the cloud service platform;
generating, based on the multi-modal data, a maintenance cost curve of the target server and at least one of a server additional value curve of the target server and a replacement server cost line of a replacement server; and
determining decommissioning timing recommendation of the target server according to the maintenance cost curve and at least one of the server additional value curve and the replacement server cost line.

20. A computer program product for providing timing recommendation of server decommissioning in a cloud service platform, comprising a computer program that is executed by at least one processor for performing operations comprising:
obtaining multi-modal data associated with decommissioning-decision made to a target server in the cloud service platform;
generating, based on the multi-modal data, a maintenance cost curve of the target server and at least one of a server additional value curve of the target server and a replacement server cost line of a replacement server; and
determining decommissioning timing recommendation of the target server according to the maintenance cost curve and at least one of the server additional value curve and the replacement server cost line.
